(19) United States
(12) Patent Application Publication
(10) Pub. No.: US 2026/0244927 A1
(43) Pub. Date: Aug. 20, 2026

(54) METHOD FOR GENERATING USER-CUSTOMIZED NEURAL NETWORK BASED ON VISUALIZATION AND APPARATUS FOR THE SAME

(71) Applicant: ELECTRONICS AND TELECOMMUNICATIONS RESEARCH INSTITUTE, Daejeon (KR)

(72) Inventors: Hyun Woo CHO, Daejeon (KR); Seon Tae KIM, Daejeon (KR); Ik Soo SHIN, Daejeon (KR); Chang Sik CHO, Daejeon (KR); Ji Young KWAK, Daejeon (KR); Hong Soog KIM, Daejeon (KR); Jae Bok PARK, Daejeon (KR); Jin Wuk SEOK, Daejeon (KR); Joon Sun AUH, Daejeon (KR); Kyung Hee LEE, Daejeon (KR)

(21) Appl. No.: 19/442,591

(22) Filed: Jan. 7, 2026

(30) Foreign Application Priority Data
Feb. 20, 2025 (KR) 10-2025-0022072

(51) Int. Cl. G06N 3/082

(52) U.S. Cl. CPC G06N 3/082

(57) ABSTRACT

Disclose are a method for providing a tool for generating a user-customized neural network based on the visualization technology and an apparatus for the same. A method for generating a neural network based on visualization may include indicating a plurality of nodes to which a variable input tensor dimension is applied to each; verifying validity for each connection between the plurality of nodes; and generating the neural network model as soon as validity for all connections between the plurality of nodes is accepted.

### CROSS REFERENCE TO RELATED APPLICATION

This application claims priority to Korean Patent Application No. 10-2025-0022072, filed Feb. 20, 2025, which are hereby incorporated by reference in its entirety into this application.

### BACKGROUND

### 1. Technical Field

The present disclosure relates to neural network generation, and more particularly, relates to a method for providing a tool for generating a user-customized neural network based on the visualization technology and an apparatus for the same.

### 2. Description of Related Art

Modifying, adding or deleting a computational operation configuring a neural network structure may be as large in resource consumption as newly constructing a neural network. In addition, there is a limit on pre-constructing a neural network for various purposes.

Accordingly, a software tool is required that may configure a customized neural network without coding and learn a model by disassembling and recombining a machine learning (e.g., deep learning) neural network structure to ensure that it is flexible and reusable.

### SUMMARY

The present disclosure is to provide a method for providing the machine learning operations (MLOps) technology that edits the computational operation of a neural network structure through visualization for a neural network structure and an apparatus for the same.

The present disclosure is to provide a method and an apparatus that may edit the component of a visualized neural network, verify an edited neural network and finally generate a learned model beyond the function of a viewer to simply show a neural network structure.

The technical objects to be achieved by the present disclosure are not limited to the above-described technical objects, and other technical objects which are not described herein will be clearly understood by those skilled in the pertinent art from the following description.

A method for generating a neural network based on visualization according to an embodiment of the present disclosure may include indicating a plurality of nodes to which a variable input tensor dimension is applied to each; verifying validity for each connection between the plurality of nodes; and generating the neural network model as soon as validity for all connections between the plurality of nodes is accepted.

An apparatus for generating a neural network based on visualization according to an additional embodiment of the present disclosure may include at least one user interface and at least one processor. The at least one processor may be configured to indicate a plurality of nodes to which a variable input tensor dimension is applied to each through the at least one user interface; verify validity for each connection between the plurality of nodes; and generate the neural network model as soon as validity for all connections between the plurality of nodes is accepted and indicate the same through the at least one user interface.

A processing unit for generating a neural network based on visualization according to an additional embodiment of the present disclosure may include at least one processor; and at least one computer memory operably connected to the at least one processor and based on being executed by the at least one processor, storing instructions for performing an operation for generating a plurality of nodes to which a variable input tensor dimension is applied to each; an operation for verifying validity for each connection between the plurality of nodes; and an operation for generating the neural network model as soon as validity for all connections between the plurality of nodes is accepted.

At least one non-transitory computer-readable medium for storing at least one instruction according to an additional embodiment of the present disclosure may control an apparatus to perform an operation for indicating a plurality of nodes to which a variable input tensor dimension is applied to each; an operation for verifying validity for each connection between the plurality of nodes; and an operation for generating and indicating the neural network model as soon as validity for all connections between the plurality of nodes is accepted by being executed by at least one processor.

In some embodiments of the present disclosure, the variable input tensor dimension for a specific node may be determined based on the output tensor dimension of a node before the specific node.

In some embodiments of the present disclosure, for connection validity for a reduction operation in which the number of outputs is less than the number of inputs, a connection may be accepted when a plurality of inputs have a corresponding size and shape.

In some embodiments of the present disclosure, the reduction operation may be a sum operation or a concatenation operation.

In some embodiments of the present disclosure, when the connection is not accepted for the sum operation, one of i) the reshape sum, ii) the dimension change sum, or iii) connection rejection may be proposed to a user, and the connection validity may be verified again based on the user's selection.

In some embodiments of the present disclosure, when the connection is not accepted for the concatenation operation, one of i) the reshape sum, ii) the dimension change sum, and iii) a concatenable option may be proposed to a user, and the connection validity may be verified again based on the user's selection.

In some embodiments of the present disclosure, each of at least one node excluding a start node and an end node among the plurality of nodes has at least one input and at least one output, and a connection between the output of the first node and the input of the third node may be allowed only when the input of the first node is connected to the second node.

In some embodiments of the present disclosure, in response to editing for the plurality of nodes, validity for each connection between the plurality of nodes may be verified again.

In some embodiments of the present disclosure, editing for the plurality of nodes may include at least one of deleting a part of the plurality of nodes, adding at least one new node other than the plurality of nodes, or modifying the relative location or structure of a part or all of the plurality of nodes.

In some embodiments of the present disclosure, editing for the plurality of nodes may be performed before the neural network model is generated or may be performed after the neural network model is generated.

In some embodiments of the present disclosure, one node may be indicated by being expanded to at least one lower node, or at least one node may be indicated by being reduced to one higher node.

In some embodiments of the present disclosure, for each of the plurality of nodes, a new output variable may be allocated to a new operation within a node.

In some embodiments of the present disclosure, a new node may be defined through configuration or modification for at least one argument for a specific node.

In some embodiments of the present disclosure, the at least one argument may include at least one of a lower node option, a numeric option, a boolean option, or a categorized node option.

In some embodiments of the present disclosure, a categorized node option is applied to the plurality of nodes and indicated as at least one group, and when a plurality of groups are indicated, validation for a connection between the plurality of groups may be performed.

In some embodiments of the present disclosure, one group may be indicated by being expanded to at least one lower group or at least one node, or at least one group may be indicated by being reduced to one higher group.

In some embodiments of the present disclosure, validation for the connection may be performed dynamically, and the connection may be applied as soon as the connection is accepted.

The features briefly summarized above with respect to the present disclosure are just an exemplary aspect of a detailed description of the present disclosure described below, and do not limit a scope of the present disclosure.

### BRIEF DESCRIPTION OF DRAWINGS

FIG. 1 is a diagram representing an example of a hierarchical node configuration according to the present disclosure.

FIG. 2 represents an example of a multi-input node according to the present disclosure.

FIG. 3 represents another example of a multi-input node according to the present disclosure.

FIG. 4 represents examples of a lower node option according to the present disclosure.

FIG. 5 represents examples of a numeric option according to the present disclosure.

FIG. 6 is a diagram for describing an example of a method performed in a neural network generation apparatus according to the present disclosure.

FIG. 7 represents an example of a block diagram of a visualization-based neural network generation apparatus according to the present disclosure.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of “and/or” includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure. Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

As the deep learning field has been developed rapidly, the time of developing the neural network of an entirely new structure or algorithm is passing. For example, a method is being introduced that generates an enhanced model suitable for the purpose of use and the environment of used hardware by assembling, disassembling or rearranging previously developed algorithms or computational operations for a state-of-the-art (SOTA) neural network instead of an SOTA neural network developed by using a data set disclosed for general purposes.

NAS (neural architecture search) and HPO (hyperparameter optimization) technologies may be considered as a technology for reflecting these requirements. However, because these technologies are a method for finding an optimal point within a search space, there are problems that they require a lot of computing time and a final result does not provide a special insight. For example, there is a question that a result according to a corresponding technology is truly the best, and it is very difficult to identify information about which component played a significant role. Finally, NAS and HPO must be performed again for similar but slightly different cases to perform a process for finding a new optimal point.

Accordingly, a new MLOps tool is required that may easily identify the role of a computational block among a variety components configuring a neural network and may allow a user to understand and learn a neural network through this.

Meanwhile, several tools such as netron, tensorboard, etc. have been developed as a neural network visualization technology. They provide visual configuration information for a neural network, and in particular, may effectively visualize the neural network model of a graph where a connection between blocks is fixed. However, for a dynamic graph-based model such as PyTorch, which is a type of a machine learning library, there is a problem that a connection, order or a structure between components is not expressed properly. In addition, a neural network may not be edited, and when it is arbitrarily modified, its neural network model does not work, so it is just used for reference, and if it needs to be modified, it is required to rework at a code level. These existing neural network visualization technologies function as a simple viewer that simply shows a neural network structure.

The present disclosure describes a new method that provides a function to visualize a neural network and edit and verify a visualized block dynamically or in real-time and provides a visualization tool for finally generating a learned model.

Before a specific description for various examples of the present disclosure, the basic unit module of a neural network is defined as “node” in the present disclosure. A node may be described based on the neural network unit module class of a specific framework. For example, when a neural network unit module class is A, A may be considered a class where the definition of an operation for an input, the forward propagation of an operation result, the differential (or gradient) calculation of a defined operation and the backward propagation of that differential value, etc. are defined. For example, for PyTorch, a torch.nn. Module class may correspond to a unit module class. In the present disclosure, a neural network that uses this basic unit module as the smallest node may be configured.

Next, a relationship between layers which go out from the output of a previous layer and go into the input of the next layer may be visualized as a line. In the present disclosure, such a line may be defined as “connection”.

Based thereon, examples of the present disclosure for code visualization are described below.

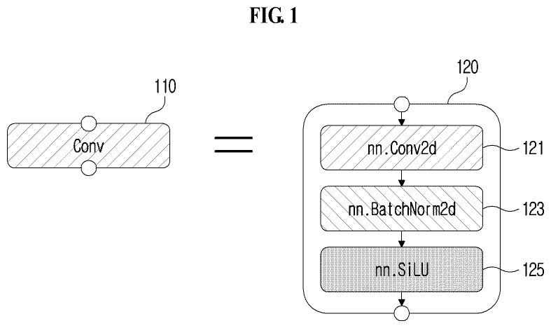

A node may be configured with a combination of multiple basic modules. For example, in the vision field, for a convolution operation block, a structure is generally used that a batch normalization operation block is followed and then, an activation function operation is applied. The visualization of a node is described in more detail by referring to FIG. 1.

FIG. 1 is a diagram representing an example of a hierarchical node configuration according to the present disclosure.

One convolutional (Conv) node 110 in FIG. 1 may have a hierarchical structure, and may be expressed by being expanded into three lower nodes 121, 123 and 125. In other words, the convolution node 110 is a relatively higher node, and the nn.Conv2d node 121, the nn.BatchNorm2d node 123 and the nn.SilU node 125 correspond to a relatively lower node. The structure 120 which simultaneously expresses a lower node and a higher node may be hierarchically visualized as a node-in-node.

An exemplary code corresponding to an exemplary convolution node in FIG. 1 is as shown in Table 1.

```
TABLE 1
class Conv(nn.Module):
  def_init_(self, c1, c2, k=1, s=1, p=None, g=1, act=True):
    super(Conv, self)._init_( )
    self.conv = nn.Conv2d(c1, c2, k, s, autopad(k, p), groups=g, bias=Fa1se)
    self.bn= nn.BatchNorm2d(c2)
    self.act = nn.SiLU( ) if act is True else (act if isinstance(act, nn.Module) else nn.Identity( ))
  def forward(se1f, X):
    return se1f.act(se1f.bn(se1f.conv(x)))
```

Hereinafter, specific examples of visualization-based neural network editing/generation according to the present disclosure are described based on the above-described node and connection between nodes. In the present disclosure, a connection may be performed/applied at any time (or simultaneously, in real time, dynamically) with validation. For example, whether a connection between nodes is adapted may be reflected immediately after verification on whether a connection is possible or not (or accepted or not) is performed. Particularly, it may be useful when a dynamic configuration such as the eager execution of PyTorch or TensorFlow is supported.

In the present disclosure, the dimension of an input tensor for one node is not defined in advance or in a fixed way. The dimension of an input tensor for each node used to configure a neural network must be variable. For example, the dimension of an input tensor for one node must be determined variably according to the dimension of the output tensor of a preceding node connected to that node. In other words, the dimension of the input of a corresponding specific node may be determined adaptively according to the output of a node to which the input of a specific node is connected.

If a neural network is not specified by a code itself, but a neural network is defined in the unit of a module and a neural network configuration is described by using an external serialization format like YAML or JSON, it is useful to define a node with such a variable input dimension.

For example, for a convolutional neural network (CNN) which is mainly used in the vision field, the dimension of an output data tensor is changed according to a convolution operation. Accordingly, when the dimension of the input data tensor of a specific node is defined in advance, a neural network becomes fixed, making it difficult to edit.

The present disclosure does not simply show a neural network model visually, but may provide a tool with a new feature that verifies connection validity in real time by considering the possibility of a forward propagation/backward propagation operation from the moment the structure of a neural network is edited.

The validation of a connection may be performed largely in two aspects. One is the validity of the number of connections according to the computational operation of an input node, and the other is the possibility of a connection according to whether a data size between an output node and an input node matches.

First, a description for the validity of the number of connections is as follows. Basic nodes may be assumed as a simple block composed of one input port and one output port. Conversely, there may be a node that allows multiple inputs. The common ground of these nodes is that an operation which has a reduction effect on an internal computational operation (i.e., a reduction operation) is included.

The connection validation of a reduction operation is described in more detail through an example such as a sum operation, a concatenation operation, etc.

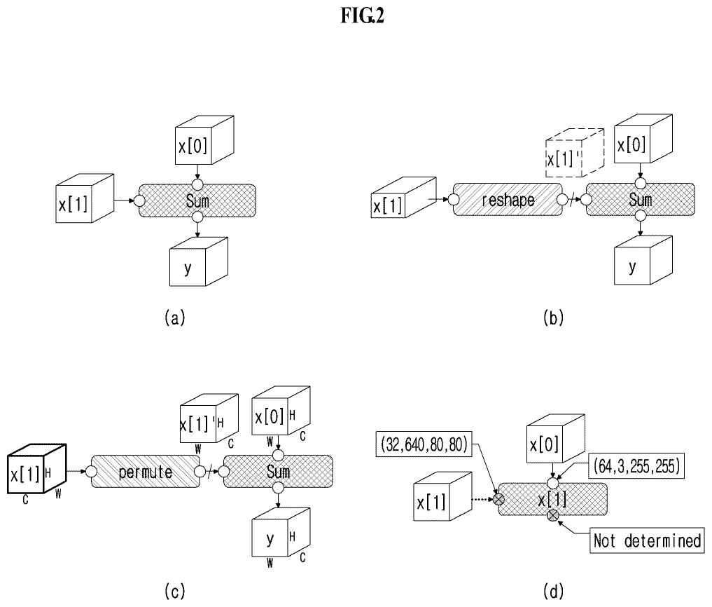

FIG. 2 represents an example of a multi-input node according to the present disclosure.

For example, a sum operation may correspond to an operation that combines multiple tensors of the same size and shape in an element-to-element way. Here, a reduction effect refers to an effect of reducing the number of input-output data in a process during which one output data is derived based on multiple input data.

For a node illustrated in FIG. 2(a), a visualization tool according to the present disclosure may accept a connection after verifying that all inputs (x[0], x[1]) have the same size and shape ([Batch(N), Channel(C), Height(H), Width(W)]).

When it is not accepted, three additional options may be proposed.

As the first example, a case may be assumed that a size and a shape do not exactly match, but the total number of elements matches. For example, it is a case of N_0*C_0*H_0*W_0=N_1*C_1*H_1*W_1. As shown in FIG. 2(b), the summation may be attempted by adding a node (e.g., a reshape node) that transforms the size and shape of the remaining input x[1] according to the size and shape of the first input x[0] and may be expressed visually, helping a user avoid (or reject) a wrong connection or easily apply (or accept).

The second example is a special case of the first example, which is a case in which the notation of a tensor is different. In this case, rather than adding elements one by one in order (e.g., an example in FIG. 2(b)), the order itself may be changed to perform modification in order to have the same size and shape. Referring to an example in FIG. 2(c), in case of x[0], a tensor is expressed in the order of (N, C, H, W), but in case of x[1], a tensor may be expressed in the order of (N, H, W, C). In this case, an order permute node may be applied to x[1] to express a tensor in the same order of (N, C, H, W) as x[0]. In other words, by changing the order of dimensions by using a permute node, modification may be performed to ensure the sum operation of two input tensors.

The third example assumes a case in which the total number of elements does not match. Referring to FIG. 2(d), in this case, a connection is automatically rejected, and a reason thereof may be indicated, providing a user with an opportunity to review the connection of a neural network.

An exemplary pseudo code for this may be expressed as shown in Table 2. An algorithm in Table 2 may be referred to as element-wise sum with verification check. The assumption of an example in Table 2 is as follows:
Input: X(Tensor List), X=x[0], x[1], . . . , x[n]
Output: Y(One Tensor), Σ{x[i] or x′[i] or x″[i]}
   Use x[0] as a basis for an operation.
   Total Number of Elements=Product of Each Dimension (e.g., if x[0]=(N,C,H,W), N*C*H*W).

Compare x[0] and x[k] for the entire input list (k=1, 2, . . . , n).

When output y is not ‘not determined’ as a result of applying a routine in Table 2 to the entire input,
accept a connection.

TABLE 2
If the total number of elements is the same
If the value of each dimension is also the same (a)
y←y+x[k]
Else (i.e., if the value of a dimension is different)
If a size and a shape are the same when the order of
dimensions is changed (c)
x′[k]←permute(x[k],x[0]) // add a permute node
y←y+x[k]′
Else (i.e., if they are not the same when the order of
dimensions is changed) (b)
x[k]″?-reshape(x[k],x[0]) // add a reshape node
y←y+x[k]″
Else (i.e., if the total number of elements is different) (d)
Reject a node connection and indicate the size and
shape of each input
Indicate output y as ‘not determined’

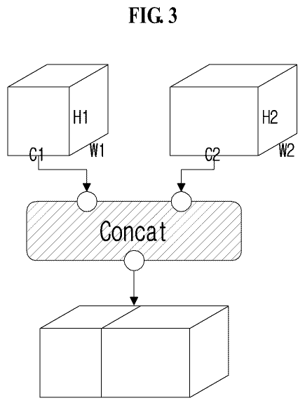

FIG. 3 represents another example of a multi-input node according to the present disclosure. For a channel direction concatenation operation such as an example in FIG. 3, tensors where the width(W) and the height(H) are the same but a channel (C) has no limit may be concatenated in a channel direction for two or more input data and output as one tensor.

A direction in which concatenation will be performed may be configured by the argument of a corresponding node. It is assumed that when nothing is performed, a channel direction is configured basically. The dimension order of a tensor determined independently may be typically applied to one neural network generation framework. A different framework may use a different notation.

For example, when channel direction concatenation is expressed, a dimension may be configured as 3 when the dimension notation of a tensor is the order of batch(N), height(H), width(W) and channel(C) (i.e., NHWC notation). On the contrary, when an NCHW notation is used, dim=1 may be configured. Such a configuration may represent concatenation in a channel direction.

Similar to a sum operation, connection validation may also be applied to a concatenation operation. As described above, for channel direction concatenation, a connection may be accepted only when all of the batch(N), width(W) and height(H) of each input tensor have the same size and shape.

When it is not accepted, three additional options may be proposed.

As the first example, a case may be assumed that a size and a shape do not exactly match, but the number of elements excluding the size of a dimension (e.g., a channel) in a concatenation direction matches. For example, it is a case of N_1*H_1*W_1=N_2*H_2*W_2. In this case, concatenation may be attempted by adding a node (e.g., a reshape node) that changes the size and shape of the remaining input (e.g., x[1]) into the size and shape of the first input (e.g., x[0]), which may be visually expressed, making a user easily accept or reject it.

As the second example, as the special case of the first example, a case in which a tensor is expressed differently may be assumed. In this case, the order itself may be changed instead of concatenating elements one by one according to a current notation to ensure that they have the same size and shape. In this case, concatenation may be attempted by adding an order permute node and changing the order of dimensions, which may be visually expressed, making a user accept or reject it.

As the third example, a case in which the total number of elements does not match may be assumed. Like a sum operation, a concatenation operation may also automatically determine connection rejection and allow a user to review a neural network connection in this case. However, in a neck structure usually seen frequently in an image object detection neural network in the vision field, there are many attempts to improve detection accuracy according to an object size by fusing the features of different resolutions (e.g., H and W are different). Considering this, it may be required to support a case in which at least two tensors with a different number of elements are concatenated into one. Accordingly, the advantageous effect of proposing to a user guidelines for disassembling a neural network which is the main feature of the present disclosure and assembling it again like Lego blocks may be maximized. According to the present disclosure, even when the total number of elements does not match, an option to concatenate in a channel direction according to the resolution in a concatenation node may be automatically provided.

For channel direction concatenation, an exemplary procedure for this may be performed as follows.

Step 1: A concatenation (concat) node may preconfigure the resolution (H,W) of an output tensor. For flexible use, it may be determined as a multiple of the input data resolution (e.g., H, W) instead of being determined as a fixed value. For example, if this value is determined as 8, when the H, W of an input image is (640,640), (80,80) which is ⅛ of it may become the output tensor H,W of this concatenation node.

Step 2: The resolution of all input tensors may be adjusted to match the resolution of an output tensor configured in Step 1. Here, to prevent the excessive loss of information, the length of C (channel) may be increased or decreased by increased or decreased (H,W). For example, if one of the input tensors needs to be reduced to ½ of an original value to match the resolution of the output tensor of this concatenation node, the channel length of a corresponding input tensor may be adjusted to be two times the original. Various nodes may be used for this purpose, but a convolution node may be basically utilized to reduce resolution, and an upsampling node may be utilized to increase resolution.

Step 3: When it is not a multiple of 2, padding may be appended to order the size.

Even when it is not a reduction node, connection validity between nodes must always be accepted after being verified. If the output of node A is connected to node B, the shape of the output tensor of node A must match input conditions defined by node B. For most nodes, the shape of an output tensor may be changed according to the shape of the input tensor of that node.

Accordingly, an important basic principle in the connection of a visualization module is that the output port of that node may be connected to the input port of another node only when all input ports of that node are connected first. The only exception is a data input node which corresponds to a start node, and is visualized as if it has only an output port without an input port, which is because the dimension of an input data tensor is determined internally. By including this, the following principles may be applied to the editing of a visualization module.

Principle 1: One start node (e.g., data input node) S must basically exist in a neural network.

Principle 2: Every node X excluding start node S has at least one input port and at least one output port.

Principle 3: For every node X excluding start node S and end node E, a connection between the output port of node X and the input port of another node C is allowed only when its input port(s) are already connected to other nodes P(s).

Principle 4: Node P and node N are a different node (prevent infinite rotation).

Principle 5: When going back to a node connected to the input port of any node X (e.g., node P1), another node P2 connected to the input port of corresponding node P1, . . . , they are necessarily connected to start node S.

Principle 6: For end node E, its output port is not connected to the input port of any other node.

Principle 7: At least one end node must exist in a neural network (prevent infinite rotation).

Principle 8: For a reduction operation node (e.g., a node in which the number of output ports is less than the number of input ports), connection acceptance/node addition/rejection options are applied after verifying a shape between input tensors.

Hereinafter, examples of the present disclosure for the coding of a visualization module are described.

The coding function of a visualization module which is the key function of the present disclosure may be considered as the editability of a neural network. Just like assembling Lego blocks, the order and batch of multiple nodes may be changed, a large node may be generated by connecting multiple nodes, and the internal node (or lower node) of one node may be modified or may be disassembled into small nodes (or lower nodes). When all connections are valid during this process, it may operate immediately as a code. It is possible because the components of all nodes inherit a basic neural network unit module class. For this purpose, an operation within each node must be written to separate input data and output data spaces. For example, even for the simple addition and multiplication, coding may be performed to ensure the reallocation of variables.

Table 3 is an example representing a comparison between an in-place operation and a non-in-place operation.

TABLE 3

| | | Non-in-place |
|---|---|---|
| Operation | In-place Operation | Operation |
| Arithmetic | x+=y or | x=x+y |
| Addition | x.add(y) | or |
| | | z=x+y |
| List | y[...,0:2]=y[...,0:2]*2- | x,w,r=y.split |
| Slicing | 0.5y[...,2:4]=y[...,2:4]**2 | ((2,2,81),4) |
| | | x=x*2-0.5 |
| | | w=(w*2) ** 2 |
| | | y=torch.cat |
| | | ((x,w,r),4) |

As shown in the example of Table 3, an in-place operation is a method for overwriting an output variable at the existing memory location, and a non-in-place operation is a method for newly allocating an output variable to a memory. The results of an in-place operation and a non-in-place operation in Table 3 are completely the same, but an in-place method for changing only a value from the existing memory variables without newly allocating an output variable to a memory makes smooth conversion between a visualization module and a code difficult. Accordingly, in the present disclosure, a non-in-place method may be applied. A neural network unit module class and all node classes generated by inheriting that class have input arguments. It may be used to apply multiple options to a corresponding node, and may be useful to reuse one node without individually generating a similar but slightly different node. Accordingly, various options (or modifications) based on various arguments may be supported for a visualization module according to the present disclosure.

In order to support the free editing of a hierarchical node (or the above-described node-in-node) and allow various variants/modifications corresponding to different input arguments at the top level of node, all options may also be defined hierarchically and connectivity with an internal node may be indicated.

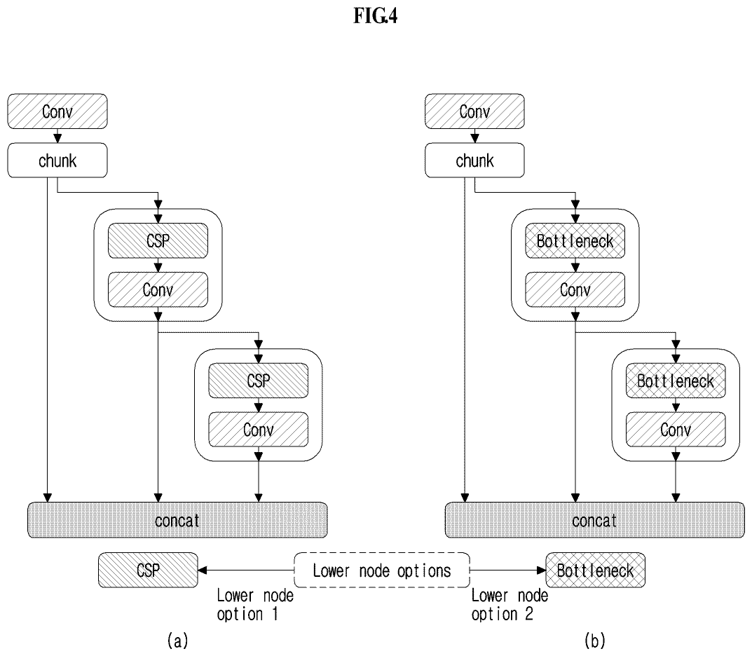

FIG. 4 represents examples of a lower node option according to the present disclosure.

In the example of FIG. 4, the option of a CSP node which is an internal node may be configured as the top level of input argument for a node with a complex structure called GELAN. FIG. 4(a) corresponds to an example in which a user applies a CSP node as a lower node option, and FIG. 4(b) represents an example in which a node corresponding to a CSP node in FIG. 4(a) is substituted with a bottleneck node.

In the present disclosure, the efficiency of neural network editing may be improved by allowing lower node(s) of the same location/structure to be easily changed at once through a higher option for a node that is already generated in this way.

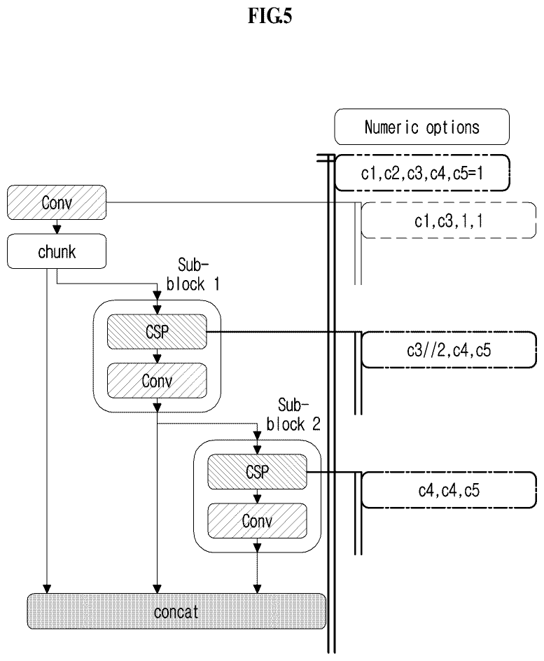

FIG. 5 represents examples of a numeric option according to the present disclosure.

There is a numeric argument that changes the value of a variable required by a node. The value of a variable or a parameter applied to a node may be entered as an integer or a floating-point real number without changing the internal structure or component of a node.

In the example of FIG. 5, when ‘view details’ is not activated, it may be visualized that a sub-block (or group) of the same structure is repeated twice. For example, sub-block 1 and sub-block 2 may be visualized as being the same, easily identifying a node configuration while maintaining the overall consistency.

Meanwhile, when ‘view details’ is activated, a difference between each node may be confirmed. For example, the top Conv node may indicate that numeric arguments of c1, c2, c3, c4, c5=1 are being applied, the CSP node of sub-block 1 may indicate that numeric arguments of c3//2, c4, c5 are being applied, and the CSP node of sub-block 2 may indicate that numeric arguments of c4, c4, c5 are being applied.

A node visualized in this way may be coded as shown in Table 4.

```
TABLE 4
class GELAN(nn.Module):
  # csp-elan
  def_init_(zelf, c1, c2, c3, c4, c5-1):
    super( )._1nit_()
    self.c = c3//2
    sulf.cv1 = Conv(c1, c3, 1, 1)
    self.cv2 = nn.Sequential(CSP(c3//2, c4, cs), Conv(c4, c4, 3, 1))
    self.cv3 = nn.Sequential(CSP(c4, c4, c5), Conv(c4, c4, 3, 1))
    self.cv4 = Conv(c3+(2*c4), c2, 1, 1)
  def forward(self, x):
    y = list(self.cv1(x).chunk(2, 1))
    y.extend((m(y[-1])) for m in [self.cv2, self.cv3])
    return self.cv4(torch.cat(y, 1))
```

Next, a boolean argument may be defined that determines whether a specific component is included or accepts true and false among the arguments of a basic module as a value. A boolean argument makes a significant difference in terms of visualization. For example, in a bottleneck node, a case in which a skip connection exists and a case in which a skip connection does not exist may be considered. It visually shows a different configuration between a case in which a skip connection exists and a case in which a skip connection does not exist, but it may be implemented in the same way on a code.

Next, it may support not only the configuration of a vertical relationship such as a node-in-node, but also the configuration of a horizontal relationship that groups a node with a similar characteristic and structure into the same category (e.g., a categorized node option). For example, various convolution configurations may be defined as belonging to the same one category.

For example, nodes (a), (b) and (c) belong to the same one convolution category may be assumed. (a) consists of general convolution, batch normalization (BN) and activation (ACT) functions. (b) consists of depth-wise separable convolution, BN and ACT. (c) consists of dilated convolution, BN and ACT. Each of (a), (b) and (c) may be classified as having a slightly different key operator, but basically has a similar/corresponding configuration, so all of them may be defined as belonging to one category called a CONV node.

These categorized nodes may offer efficiency beyond simply being classified as a node of the same color in a visualization module. For example, when you want to change ACT input to all convolution nodes from ReLU to SiLU in a state in which a neural network where nodes (a), (b) and/or (c) are mixed is configured, instead of individually selecting and modifying all nodes, a function that applies a modification to nodes belonging to a convolution node category in general may be implemented. For an option in this case, a module name that may be used as an actual node, not a numeric value or a boolean value, may be allowed.

In the present disclosure, an input argument may include a basic option (a numeric option) that may change the value of a parameter applied to a node, a boolean option that is indicated as true/false and may change a connection or a lower node configuration within a node and an option that directly inputs ‘a node’ as an input argument (e.g., a lower node option and/or a categorized node option).

Hereinafter, examples in which the present disclosure is utilized are described.

There are many attempts to improve the accuracy of neural network learning without affecting the inference speed of a model with a fixed weight after neural network learning ends. It is referred to as Bag-of-Freebie and a variety of techniques are applied. For example, to improve the accuracy of learning, nodes may be additionally input to define and learn an auxiliary loss function other than a basic loss function. When mixed with basic nodes, these additional nodes are very complex and by any possibility, even a person who coded them has difficulty in finding the completeness of a connection or a bug. When the visualization-based module tool of the present disclosure is utilized, it may be dramatically enhanced. First, auxiliary nodes may be grouped by using a categorized node option to visually indicate attachment and detachment at the learning and inference steps. In addition, after connection validation is performed at the step of configuring a neural network by using a visualization module, the coding of a visualization module is performed only when it is valid, so human errors may be reduced.

Bag-of-specialty may also consider changing the structure or order of an inference neural network to improve the accuracy of a neural network. The existing NAS may also be considered as one of those bag-of-specialties. It may be effectively expressed by configuring a special node.

One of the advantages of generating a neural network by using a visualization tool is that it is possible to dissect a neural network. A neural network itself implemented through coding is often a black box, and it is very difficult to confirm which node has a significant effect on a final output (e.g., a loss value during learning, a prediction value during inference). A visualization tool provides very excellent convenience and insight when comparing various neural networks or modifying some of them.

It also allows a neural network to be conversely composed of semantic blocks in a larger unit. For example, for an objection perception neural network in the vision field, it may be largely divided into a backbone that extracts features and a head that predicts the location and class of an object based on extracted features. And, in some cases, a head may be further divided into a neck that fuses feature values for each resolution (feature fusing) and a narrow head that performs actual prediction. And, it is possible to attempt a variety of configurations by separating it from each well-known SOTA neural network and making it into a higher block.

As such, a neural network generation tool based on a visualization module provides very extensive convenience and expandability, and may generate a desired neural network and analyze a result thereof with almost no coding.

According to the configuration and procedure of the present disclosure, there are advantages that the generation of a neural network may be performed easily and quickly without coding or with minimal basic coding alone and a function such as neural network dissection for optimization and comparison tests such as NAS and HPO may be implemented through the editing of a visual module.

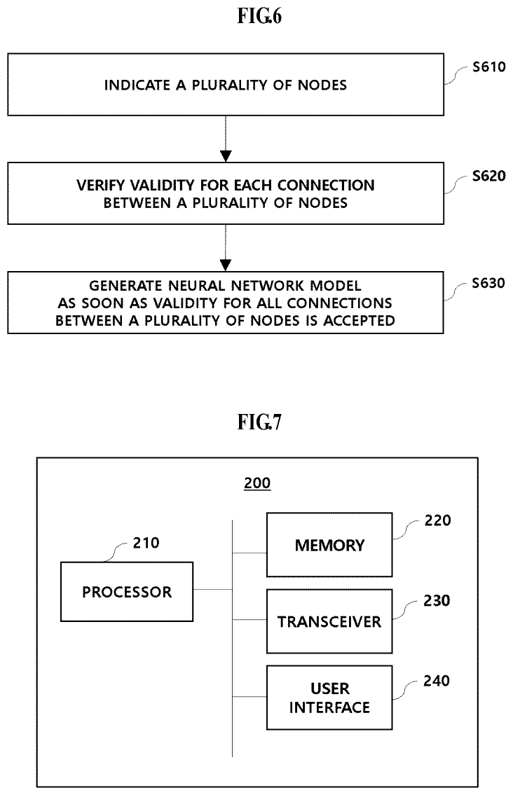

FIG. 6 is a diagram for describing an example of a method performed in a neural network generation apparatus according to the present disclosure.

In S610, an apparatus may indicate a plurality of nodes.

For example, a variable input tensor dimension may be applied to each of a plurality of nodes. In addition, a variable input tensor dimension for a specific node may be determined based on the output tensor dimension of a node before a specific node.

For example, one node may be indicated by being expanded to at least one lower node, or at least one node may be indicated by being reduced to one higher node.

For example, for each of a plurality of nodes, a new output variable within a node may be allocated to a new memory location.

For example, a new node may be defined through configuration or modification for at least one argument for a specific node. In this case, the at least one argument may include at least one of a lower node option, a numeric option, a boolean option, or a categorized node option.

When a plurality of nodes are indicated as at least one group, one group may be indicated by being expanded to at least one lower group or at least one node, or at least one group may be indicated by being reduced to one higher group.

In S620, an apparatus may verify validity for each connection between a plurality of nodes.

For example, for connection validity for a reduction operation in which the number of outputs is less than the number of inputs, a connection may be accepted when a plurality of inputs have a corresponding size and shape. For example, a reduction operation may be a sum operation or a concatenation operation.

When a connection is not accepted for a sum operation, one of i) the reshape sum, ii) the dimension change sum or iii) connection rejection may be proposed to a user. Accordingly, connection validity may be verified again based on a user's choice.

When a connection is not accepted for a concatenation operation, one of i) the reshape sum, ii) the dimension change sum or iii) a concatenable option may be proposed to a user. Accordingly, connection validity may be verified again based on a user's choice.

For example, each of at least one node excluding a start node and an end node among a plurality of nodes may have at least one input and at least one output. In addition, a connection between the output of the first node and the input of the third node may be allowed only when the input of the first node is connected to the second node.

For example, in response to editing for a plurality of nodes, validity for each connection between a plurality of nodes may be verified again. Here, editing for a plurality of nodes may include at least one of deleting some of a plurality of nodes, adding at least one new node other than a plurality of nodes or modifying the relative location or structure of some or all of a plurality of nodes. In addition, editing for a plurality of nodes may be performed before a neural network model is generated or may be performed after a neural network model is generated.

For example, when a plurality of groups are indicated for a plurality of nodes, validation for a connection between a plurality of groups may be applied.

Validation for this connection may be performed dynamically, and a connection may be applied as soon as a connection is accepted.

In S630, an apparatus may generate a neural network model as soon as validity for all connections between a plurality of nodes is accepted.

For example, generating a neural network model may include generating/updating a code for a neural network model.

FIG. 7 represents an example of a block diagram of a visualization-based neural network generation apparatus according to the present disclosure.

The visualization-based neural network generation apparatus 200 may include at least one processor 210, at least one memory 220, at least one transceiver 230, at least one user interface 240, etc. The memory 220 may be included in the processor 210 or may be configured separately. The memory 220 may store instructions that causes the apparatus 200 to perform an operation when being executed by the processor 210. The transceiver 230 may transmit and/or receive a signal, data, etc. that are exchanged by the apparatus 200 with other entities. The user interface 240 may receive a user's input for the apparatus 200 or provide the output of the apparatus 200 to a user. Among the components of the apparatus 200, components other than the processor 210 and the memory 220 may not be included in some cases, and other components not illustrated in FIG. 7 may be included in the apparatus 200.

The processor 210 may be configured to cause the apparatus 200 to perform the operation of an apparatus according to various examples of the present disclosure. Although not illustrated in FIG. 7, the processor 210 may be configured as a set of modules for performing each function. A module may be configured in the form of hardware and/or software.

For example, the processor 210 may be configured to indicate a plurality of nodes through the at least one user interface 240, verify validity for each connection between a plurality of nodes, and generate a neural network model as soon as validity for all connections between a plurality of nodes is accepted and indicate the same through at least one user interface 240.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by software and software may be recorded in a recording medium. A component, a function and a process described in illustrative embodiments may be implemented by a combination of hardware and software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

According to the present disclosure, a method for providing the machine learning operations (MLOps) technology that edits the computational operation of a neural network structure through visualization for a neural network structure and an apparatus for the same may be provided.

According to the present disclosure, a method that may edit the component of a visualized neural network, verify an edited neural network and finally generate a learned model beyond the function of a viewer to simply show a neural network structure and an apparatus for the same may be provided.

Effects achievable by the present disclosure are not limited to the above-described effects, and other effects which are not described herein may be clearly understood by those skilled in the pertinent art from the following description.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method for generating a neural network based on a visualization, the method comprising:
indicating a plurality of nodes to which a variable input tensor dimension is applied to each;
verifying a validity for each connection between the plurality of nodes; and
generating the neural network model as soon as a validity for all connections between the plurality of nodes is accepted.

2. The method of claim 1, wherein:
the variable input tensor dimension for a specific node is determined based on an output tensor dimension of a node before the specific node.

3. The method of claim 1, wherein:
for a connection validity for a reduction operation in which a number of outputs is less than a number of inputs, a connection is accepted when a plurality of inputs have a corresponding size and shape.

4. The method of claim 3, wherein:
the reduction operation is a sum operation or a concatenation operation.

5. The method of claim 4, wherein:
when the connection is not accepted for the sum operation, one of i) a reshape sum, ii) a dimension change sum, or iii) a connection rejection is proposed to a user, and
the connection validity is verified again based on the user's selection.

6. The method of claim 4, wherein:
when the connection is not accepted for the concatenation operation, one of i) a reshape sum, ii) a dimension change sum, and iii) a concatenable option is proposed to a user, and
the connection validity is verified again based on the user's selection.

7. The method of claim 1, wherein:
each of at least one node excluding a start node and an end node among the plurality of nodes has at least one input and at least one output, and
only when an input of a first node is connected to a second node, a connection between an output of the first node and an input of a third node is allowed.

8. The method of claim 1, wherein:
in response to an editing for the plurality of nodes, the validity for the each connection between the plurality of nodes is verified again.

9. The method of claim 8, wherein:
the editing for the plurality of nodes includes at least one of deleting a part of the plurality of nodes, adding at least one new node other than the plurality of nodes, or modifying a relative location or structure of the part or all of the plurality of nodes.

10. The method of claim 8, wherein:
the editing for the plurality of nodes is performed before the neural network model is generated, or is performed after the neural network model is generated.

11. The method of claim 1, wherein:
one node is indicated by being expanded to at least one lower node, or
at least one node is indicated by being reduced to one higher node.

12. The method of claim 1, wherein:
for each of the plurality of nodes, a new output variable within a node is allocated to a new memory location.

13. The method of claim 1, wherein:
a new node is defined through a configuration or a modification for at least one argument for a specific node.

14. The method of claim 13, wherein:
the at least one argument includes at least one of a lower node option, a numeric option, a boolean option, or a categorized node option.

15. The method of claim 1, wherein:
the plurality of nodes are indicated as at least one group, and
when a plurality of groups are indicated, a validation for a connection between the plurality of groups is applied.

16. The method of claim 15, wherein:
one group is indicated by being expanded to at least one lower group or at least one node, or
at least one group is indicated by being reduced to one higher group.

17. The method of claim 1, wherein:
a validation for the connection is performed dynamically, and
the connection is applied as soon as the connection is accepted.

18. An apparatus for generating a neural network based on a visualization, the apparatus comprising:
at least one user interface; and
at least one processor,
wherein the at least one processor is configured to:
indicate, through the at least one user interface, a plurality of nodes to which a variable input tensor dimension is applied to each;
verify a validity for each connection between the plurality of nodes; and
generate the neural network model as soon as a validity for all connections between the plurality of nodes is accepted, and indicate the same through the at least one user interface.

19. A processing unit for generating a neural network based on a visualization, the processing unit comprising:
at least one processor; and
at least one computer memory that is operably connected to the at least one processor, and based on being executed by the at least one processor, stores instructions for performing:
an operation for generating a plurality of nodes to which a variable input tensor dimension is applied to each;
an operation for verifying a validity for each connection between the plurality of nodes; and
an operation for generating the neural network model as soon as a validity for all connections between the plurality of nodes is accepted.
